(19) United States
(12) Patent Application Publication
(10) Pub. No.: US 2014/0096376 A1
(43) Pub. Date: Apr. 10, 2014

(54) METHOD FOR MANUFACTURING LEAD GRIDS FOR BATTERY ELECTRODES

(71) Applicants: Giuseppe Riva, Vercurago (Lecco) (IT); Giovanni Riva, Vercurago (Lecco) (IT); Alessandro Mantovani, Milano (IT)

(72) Inventors: Giuseppe Riva, Vercurago (Lecco) (IT); Giovanni Riva, Vercurago (Lecco) (IT); Alessandro Mantovani, Milano (IT)

(21) Appl. No.: 14/122,071

(22) PCT Filed: May 24, 2012
(86) PCT No.: PCT/EP2012/002223

§ 371 Date: Nov. 25, 2013

(30) Foreign Application Priority Data
May 25, 2011 (IT) PV2011A000011

(51) Int. Cl. H01M 4/04

(52) U.S. Cl. CPC H01M 4/04
USPC 29/623.1

(57) ABSTRACT

A method for manufacturing lead grids for battery electrodes includes providing a lead strip at a cutting and ablation station, cutting the lead strip by at least one laser beam that cuts and reduces the thickness of the lead strip to form a lead grid, and supporting the lead strip, at least at the cutting and ablation station, without interfering with the laser beam. The lead strip may be supported in a limited number of discrete positions which are as little as possible coincident with the cutting positions of the laser beam. Alternatively, the lead strip is supported by means transparent to the wavelength of the laser. The laser beam is focused and moved by a generally remote scanning and/or proximity head, preferably mounted on a motion system which controls its position according to a selected cutting path and controls the focal position. The process allows continuous control of the path and/or parameters of cutting and/or ablation by means of software.

The present invention relates to a method for manufacturing lead grids for battery electrodes.

The electrodes of batteries are generally constituted by lead grids manufactured in several different ways.

A conventional method of fabricating lead grids, known as gravity casting, comprises melting the lead and deposit the molten lead by gravity on a shell mold.

A casting process is also used in other conventional methods, such as the continuous casting process, where the difference with respect to the gravity casting process is the possibility to obtain a continuous production.

A variation of the continuous casting process is the continuous roll casting process, where rolling wheels are added for rolling the grid strip.

Other processes are known that use a rolled strip. The first one is known as “expanded metal” and uses two main systems: the rolling mill, in order to produce the rolled lead strip, and the expander, which cuts into the rolled lead strip and provides the grid. During this process, incisions are provided which create the meshes of the grid. As a consequence of the incision, the strands are deformed and elongated as to provide a rhomboidal mesh. Another known process, termed “punched metal”, uses a strip which is rolled through a punching press, which perforates the strip, leaving only the strip of the grid.

The above described processes have some drawbacks.

The gravity casting technology makes the crystalline structure of the lead qualitatively inferior, as regards corrosion resistance and mechanical strength; it is possible to produce grids for batteries of the AGM/VRLA type but it is not possible to manufacture the so called “wound” type. Another drawback is the need to manufacture a dedicated mold for each required geometry. A severe limitation of the gravity casting technology is a low productivity, which entails the need to use a large number of machines, and therefore of molds, to meet production requirements.

The continuous casting and continuous roll casting processes entail the use of a different casting wheel for each grid shape to be manufactured.

The expanded metal technology has drawbacks due to the stress of the nodes of the diamond design, in which microfractures form because of cutting and deformation. Those nodes are subject to corrosion and failure during the life of the battery. Moreover, with the expanded metal process, it is not possible to provide a border along four sides and in particular the two vertical sides are missing, causing poor resistance to the elongation that is typical of grids during the operation of the battery, and constituting a cause of short-circuits and failures of the battery. The lead has a better crystalline structure with respect to the lead obtained by gravity casting, thus improving corrosion resistance. On the other hand, mechanical strength is compromised by the mesh-like geometry of the grid, which lacks a frame. The expanded metal process, starting from a rolled strip, prevents the possibility of having strands of different thickness or on differentiated planes. It cannot be used to manufacture AGM/VRLA batteries and batteries with wound assemblies.

In the case of punched-metal technology, punching generates stresses in the grid. The preferred geometry for a grid has densely packed and thin strands and is not entirely suitable for punching, because in punched grids, the nodes of the strands have microfractures and residual stress, which are harmful as regards corrosion resistance. Moreover, the punched-metal process requires a punching die for each different grid shape.

WO02/069421 discloses a method of producing lead alloy strips for batteries, by extruding a lead alloy at elevated temperature to produce a strip having the desired profile, and rapidly cooling the extrude strip to acquire a desired microstructure.

WO2009/155949 discloses a device for manufacturing a strip by extrusion, comprising a groove former.

EP2124274-A1 discloses a method of manufacturing a grid for a battery plate, wherein a substantially planar web is manufactured to include a plurality of spaced apart and interconnected wire segments; the method includes reforming the wire segments.

The aim of the present invention is to provide a method for manufacturing lead grids for battery electrodes, that overcomes the above described drawbacks of the cited prior art.

Within the scope of this aim, another important object is to provide a method that ensures a flexible and high productivity of battery grids.

A further object of the invention is to provide a method that may be implemented in an apparatus requiring a minimal number of fixtures and accessories.

The above aims and other aims that will be more apparent hereinafter, are achieved by a method for manufacturing lead grids for battery electrodes, characterized in that it comprises the following steps:

providing a lead strip at a cutting and ablation station;

cutting said lead strip by means of at least one laser beam that cuts and reduces the thickness of said lead strip forming a lead grid;

supporting said lead strip, at least at said cutting and ablation station, without interfering with said laser beam.

The lead strip may be supported in a limited number of discrete positions of the lead strip, said discrete positions being as little as possible coincident with the cutting positions of said at least one laser beam. Alternatively, the lead strip is supported by means transparent to the wavelength of said laser.

Further characteristics and advantages of the present invention will become better apparent from the preferred but not exclusive description of the application of laser technology to the production of grids for batteries.

A lead strip is made available wound on a coil. The coil is arranged on an uncoiler, which has a horizontal rotating axis and on which the coil on which the rolled lead strip is wound is fastened. The uncoiler feeds the downstream process, rotating the coil and thus uncoiling the lead strip. The uncoiler is preferably motorized and provided with a closed-loop control system adapted to feed the downstream process synchronously, thus preventing the lead strip from being subjected to traction and preventing the uncoiler from uncoiling an excessive amount of strip.

The strip coming from the uncoiler is made to pass through one or more pairs of oppositely rotating rollers, which control the speed of the strip toward the part of the process located downstream, both if the proximity or remote laser cutting head works with a continuous process and if it works with a discrete process. The expression “continuous process” is intended to mean that the cutting head works on the moving strip, i.e., the strip fed continuously by the uncoiler and by the system of mutually opposite rollers. In this case, the grid is cut while the strip advances and the cutting head must be synchronized with the strip feeding system. The expression “discrete process” is intended to mean that the strip is made to advance in steps. The feeding system (uncoiler and mutually opposite rollers) feeds a preset amount of strip toward the cutting station. Then a new advancement of the strip occurs with simultaneous unloading of the freshly cut grids and of the manufacturing waste.

According to the present invention, the cutting and ablation process is effected by means of a laser beam that cuts and reduces the thickness of a lead strip in order to obtain a lead grid.

According to the invention, a lead strip is preferably rolled, preferably in a thickness from 0.7 to 1.0 mm, for negative plates, and a thickness from 0.9 to 1.3 mm, for positive plates.

The plates may be cut into thicknesses that are different from the ones given above by way of example. Moreover, the production process using a laser is not constrained to the use of particular alloys, since it can be applied to the cutting and ablation of any type of lead alloy for grids.

In particular, the invention uses laser technology, a technology which is known in the field of the cutting and ablation of materials, which consists of a device capable of emitting an electromagnetic radiation (beam of light) which is coherent, monochrome and, with some exceptions, of limited divergence. Moreover, the brightness (intensity) of laser sources is very high compared to that of traditional light sources. In particular, monochromaticity allows to concentrate a large amount of energy in the beam of light, which can then be focused in a point, known as focus, which is unique and therefore has an extremely high energy density. Because of the low divergence, the laser beam can be transported over long extents without losing efficiency and finally coherence allows to have a beam which is stable in terms of wavelength, frequency and phase, both in time and in space. These particular characteristics allow to utilize this radiation to perform work such as cutting and ablation.

There are basically two systems of laser cutting of materials: cutting by melting and cutting by vaporization. In both systems, the cutting process is triggered and maintained by virtue of the energy that the focused laser beam can concentrate on a very small point, thus inducing the localized melting and/or vaporization of the material being worked. Vaporization is the process that allows to perform the ablation of the material so as to reduce the thickness of the grid. Depending on the characteristics of the laser source chosen for cutting and ablation of the grid of the battery and on the type of material and power levels involved, one process or the other can prevail or both can cooperate to provide cutting and ablation.

According to the present invention, cutting and ablation is performed preferably with a high-intensity laser source, including a fiber laser source, disk laser source, fiber-launched direct diode laser. source, which, by virtue of the high intensity of the beam, facilitates the establishment of the vaporization process. Moreover, it ensures higher cutting speeds and rapid breakthrough, by virtue of the extremely high density of the beam. High-intensity sources also widen the range of materials that can be processed, by virtue of the wavelength and the intensity of the beam, which allow to cut effectively very reflective materials, such as copper and brass. Moreover, this type of source, by virtue of the high efficiency of the source (η>25%), allows a drastic reduction of the electric power consumption, which is considerably lower than the typical ones of a CO₂ source.

High-intensity sources require a compact and simple configuration by virtue of the transferability in fiber optics of the laser beam, which simplifies the structure of the machine and ensures low operating and maintenance costs, by virtue of the constructive simplicity of the source and the absence of an optical path.

The laser head performs cutting on the lead plates, as described above by way of example, according to a preset geometry. The cutting position in fact is not fixed but can be modified and selected by using software for the management of one or more cutting heads. In this manner it is also possible to optimize the work of the cutting heads as a function of the dimensions and geometry of the grid to be manufactured at a given time.

The cutting and/or ablation process is performed by means of a laser beam which is focused and moved with high dynamics by a remote scanning laser head, which is preferably constituted by a beam focusing device and by mirrors which deflect the beam, thus controlling the cutting and/or ablation path.

The mirrors are moved with very high dynamics (preferably >50 g), thus moving the laser beam at high linear speeds (preferably hundreds of m/min). The mirrors deflect the beam and virtually eliminate inertia, eliminating acceleration and deceleration transients on the cutting and/or ablation path.

The cutting process can be performed alternately or simultaneously with a proximity laser head, which comprises a device configured for focusing the laser beam and feeding an assist gas flow, at controlled pressure, from a nozzle which is coaxial to the laser beam. The coaxial gas eliminates the molten material, thus leaving a clean, flash-free cutting flap.

In order to improve the quality of the end product, it is preferable to feed a gas jet in the region of cutting and/or ablation with remote scanning head. The gas jet strikes the work area thereby limiting the temperature of the rolled lead strip and moving the residues of molten and/or vaporized material away from the surface of the strip and therefore from the grids being manufactured.

The remote scanning laser head is preferably mounted on a head motion system with at least three axes, which is adapted to move the remote scanning laser head so as to completely synchronize the cutting and/or ablation step with the advancement of the rolled lead strip being worked. Also, the head motion system allows to change the relative distance between the head and the strip, so as to adapt and optimize the focal distance to each thickness being worked.

The proximity cutting head is preferably installed on a proximity motion system with at least three axes with high dynamics, preferably axes moved by linear electric motors, so as to ensure high productivity of the cutting process. The proximity motion system controls the position of the head according to the cutting path defined in the process and controls the focus position by virtue of the possibility to translate at right angles to the rolled lead strip.

The strip that exits from the system of mutually opposite rollers is picked up by a conveyance system which is synchronous with the feeding system that supports it during advancement and laser cutting.

The proximity or remote laser head may also be configured to follow the plane variations and keep the focus of the beam on the strip, but such construction would increases the complexity of the system and might partially compromise the quality of the final product.

However, preferably, the conveyance system supports the rolled lead strip without altering its planarity, in order to ensure that the focus of the laser beam is constantly positioned in the ideal point for cutting, thus maintaining the high quality of the cutting and ablation process and has the smallest possible surface of contact with the rolled strip.

This feature is very useful in order to ensure the high quality of the end product. During the cutting process, most of the molten material, especially in case of cutting with a proximity head, must be able to exit from the lower part of the strip and therefore it is not possible to support the strip with a continuous member. If the conveyance system is in complete contact with the rolled lead strip along all the cutting lines, in addition to worsening the quality of the finished product, it would also be worked by the laser beam, thereby causing a very high wear of the system for conveying and supporting the rolled strip being worked.

In order to obviate this problem, which does not occur regarding surface ablation, it is convenient for the conveyance system to support the strip only in some points and for these points to be located as little as possible at the cutting lines.

According to the present invention, the supporting surface is preferably constituted by a large number of thin blades that always have a point of contact with the lead of the grid, even after cutting has been performed, thus allowing better support to the grid during transport after cutting, also preventing any damage to it.

The above described system is an optimal solution to the problem of conventional systems traditionally used in the field of thermal cutting, such as for example laser and plasma cutting, where the strip is made to rest on metal stems, the cross-section of which, in the point of contact with the ribbon, is very small, so much that it can even be pointed. Such conventional system is not convenient in the present invention because the pointed stems might end up at the holes of the cut grid and might therefore engage it and ruin it during transport.

In the system according to the present invention, the blades preferably move synchronously with the system for feeding the rolled lead strip.

A system for the fixed support of the strip is also feasible but it might ruin the surface of the strip with which it comes into contact.

According to a preferred embodiment of the present invention, the motion of the blades is synchronized with the motion of the strip, by having the blades mounted on chains or belts or other such means, arranged parallel to each other, and receiving the motion from a motorized shaft, while at the opposite end they rotate about a free shaft. Members such as pinions or pulleys or others, capable of guiding and transmitting the motion of the shaft to the chains or belts, are fixed to the two shafts.

Regardless of the preferred solution of motion chosen for the rolled lead strip, be it continuous or discrete, it is possible to have multiple laser cutting heads, not just one, which work simultaneously to increase production capacity.

Multiple laser heads which work simultaneously on the same production line, i.e., on the same rolled lead strip, also allow one or some heads to cut the grid while at least one other head performs the ablation work, i.e., the partial removal of lead. This possibility is advantageous because the energy required for ablation is lower than that required for cutting and this allows to use lower-power laser sources, which allow an economic saving, in terms of initial investment and operating cost.

In order to obtain an optimum geometry for a lead grid for batteries, the ablation process preferably has a longer path of the laser beam than the cutting process. It is therefore possible to optimize the use of the laser heads by dedicating optionally a larger number of laser heads to ablation than those dedicated to cutting, but with less power.

According to a further aspect of the present invention, work on the strip and on the grids may also be effected in different positions, even offline.

For example, it is possible to cut the grids inline and then pick up the plates to work them in a different line where, for example, only ablation is performed.

From the point of view of the apparatus and fixtures required, the method according to the present invention allows to provide practically any grid geometry without having a dedicated fixture for each geometry.

This is possible because the remote scanning laser head, that orients the laser beam and controls its focus, as well as the proximity laser head, allow to modify the cutting path without requiring hardware fixtures, but simply by modifying their path via software. No other currently existing technology can provide any geometry without using special fixtures for each design.

According to the present invention, the transition from one type of grid to another one is immediate, because it is not necessary to replace the work fixtures. Also, it is possible to optimize the use of the rolled lead strip, because the grid may be formed at any point of the strip, because there is no need to assume preset positions as in dedicated hardware fixtures.

This also allows to reduce the production of waste. By virtue of this feature, it is possible to use a rolled lead strip for all types of grid to be produced; in fact, by choosing a strip suitable for the largest grid, all the other smaller grids can be obtained from the same strip by varying the cutting layout. This is an important advantage, which is not available in the prior art systems that require a strip of definite length for each grid type.

The present invention allows to optimize the production of strip, avoiding the need to produce strips having different dimensions.

The possibility to cut the grid in any position of the strip also allows to use multiple cutting and/or ablation heads simultaneously on the same strip, thereby greatly increasing the production capacity.

The present invention allows to obtain an optimum crystalline structure of the lead of the grid, because the structure is oriented longitudinally to the rolling direction, rather than at right angles to the plane of the plate as occurs in plates obtained by casting (gravity casting or continuous casting).

Moreover, contrary from expanded metal technology, the use of the laser according to the present invention allows to obtain plates provided with a reinforced frame extending on four sides and therefore having a greater resistance to elongation.

Another advantage of the present invention is the possibility to obtain differentiated thicknesses for the different strands of the grid. This is a very important feature that facilitates the process of spreading the paste and allow the paste, once dried, to remain uniformly in adhesion on the lead of the grid, limiting greatly its pellet separation. This feature cannot be obtained with expanded metal and punched metal technologies and can be obtained only partially with continuous roll casting technology.

It is possible to obtain plates to be used for making batteries with a wound assembly. These batteries require a series of grids which are mutually connected but have dimensions that vary from one grid to another so that during the winding of the assembly they have all the electrical connection flags mutually aligned. According to the prior art, only continuous casting technology can produce grids with this feature.

Grids manufactured according to the present invention can be used to manufacture AGM batteries. In fact they have no free strands, i.e., strands not connected to the frame, which might pierce the separator and cause short-circuits. Also the grids made according to the present invention are made of lead having an optimal crystalline structure.

Preferably, grids for automotive plates have large dimensions, up to 600×170 mm, and are manufactured only by gravity casting or pressure die-casting. The present invention allows to manufacture those grids starting from a rolled lead strip which ensures, by virtue of the better crystalline structure, a higher resistance to corrosion. This is extremely important for automotive batteries, which are subject to a large number of cycles with deep discharge. It is also possible to obtain tubular plates for automotive batteries, currently obtained only by die-casting.

Another advantage of the present invention regards the nodes of the grids which have none of the defects typical of grids manufactured according to the prior art. In particular, according to the present invention, it is possible to radius the edges of the nodes, giving them higher mechanical strength and corrosion resistance.

Also, it is possible to provide copper grids for lead-acid batteries in which the copper grid acts as a conductor while the paste spread on the grid acts in the chemical reaction.

The method according to the present invention may be a continuous process or a step process.

According to a practical embodiment of the continuous process, the rolled strip is uncoiled from a coil, by means of an uncoiler or unwinder, which feeds the strip into one or more pairs of counter-rotating rollers which control the feed speed of the strip downstream.

The lead strip is supported by a conveyor belt that moves with a speed equal to the feed speed, controlled by the counter-rotating rollers, so as to support the strip along the entire length required for performing the cutting and ablation of the grid.

The conveyor belt is made of blades of limited thickness, or pointed, so as to support the lead strip only in some positions so as not to influence the process of cutting and ablation.

A laser beam generated by a source of high brightness, is focused and moved on the lead strip according to the cutting path established by the software.

The motion of the beam is obtained by a scan head. The scan head, through the use of galvanometric mirrors and of the control system, moves the laser beam according to the path set at the selected speed.

The cutting is preferably performed by vaporization, wherein a volume of material is removed by vaporization along the cutting path. In order to cut through the whole thickness of the strip, the geometry of the motion is repeated at high speed for a number of times required by the thickness of the strip.

Downstream of the cutting head, one or more ablation heads perform the ablation process which consists in focusing the laser beam with power, intensity and location checked locally in order to remove the material so as to obtain a geometry of the grid with a differentiated thickness of the wires and planes.

All heads, both the cutting heads and the ablation heads, compensate the cutting path and the ablation path according to the feeding speed of the strip, ensuring a continuous process.

Downstream of the cutting station, the conveyor belt unloads the scraps of strip that are then recovered to be reused in the production process, while the grids are transported to the exit of the production system.

According to a practical embodiment of the step process, the rolled strip is uncoiled from a coil, by means of an uncoiler or unwinder, which feeds the strip intermittently into one or more pairs of counter-rotating rollers which control the feed speed of the strip downstream.

The lead strip is supported by a conveyor belt that moves with a speed equal to the feed speed, during the feed step, while it stands still during the cutting and ablation steps.

The conveyor belt supports the strip along the entire length required for performing the cutting and ablation of the grid.

The conveyor belt is made of blades of limited thickness, or pointed, so as to support the lead strip only in some positions so as not to influence the process of cutting and ablation.

A laser beam generated by a source of high brightness, is focused and moved on the lead strip, according to the cutting path established by the software.

The motion of the beam is obtained by a scan head. The scan head, by using galvanometric mirrors and of the control system, moves the laser beam according to the path set at the selected speed.

The cutting is preferably performed by vaporization, wherein a volume of material is removed by vaporization along the cutting path. In order to cut through the whole thickness of the strip, the geometry of the motion is repeated at high speed for a number of times required by the thickness of the strip.

Downstream of the cutting head, one or more ablation heads perform the ablation process which consists in focusing the laser beam with power, intensity and location checked locally in order to remove the material so as to obtain a geometry of the grid with a differentiated thickness of the wires and planes.

According to this step process, both the cutting and ablation steps are performed in successive steps while the strip stands still during each step.

The unwinding system feeds a selected length of strip downstream. Each of said cutting and ablation heads perform the required operation while the strip stands still and only after the operation is completed, a selected length of strip is advanced to the successive step.

Downstream of the cutting station, the conveyor belt unloads the scraps of strip that are then recovered to be reused in the production process, while the grids are transported to the exit of the production system.

As described above the laser source may be any suitable laser source.

The cutting operation may be performed by a proximity head instead of a scan head.

The physical cutting process may be a combination of vaporization-fusion or pure fusion.

The transport-support system may be made of plastics “transparent” to the wavelength of the laser, so as to provide a continuous support rather than a discrete support.

The cutting may be deliberately incomplete, at the outline of the grid, so as to leave the grid attached to the strip in order to rewind a coil, once the scraps have been moved away.

It has thus been shown that the process according to the present invention is advantageous because it allows to perform, with extreme precision, the cutting and ablation of lead plates having different characteristics.

This application claims the priority of Italian Patent Application No. PV2011A000011, filed on May 25, 2011, the subject matter of which is incorporated herein by reference.

1. A method for manufacturing lead grids for battery electrodes, comprising the following steps:
providing a lead strip at a cutting and ablation station,
cutting said lead strip by means of at least one laser beam that cuts and reduces the thickness of said lead strip forming a lead grid,
supporting said lead strip, at least at said cutting and ablation station, without interfering with said laser beam.

2. The method according to claim 1, wherein said lead strip is supported in a limited number of discrete positions of the lead strip, said discrete positions being as little as possible coincident with the cutting positions of said at least one laser beam.

3. The method according to claim 1, wherein said lead strip is supported by means that are transparent to the wavelength of said laser.

4. The method according to claim 1, wherein said cutting step is performed by multiple laser beams.

5. The method, according to claim 1, further comprising feeding an assist gas flow, at said cutting and ablation station, coaxially to said at least one laser beam; said coaxial gas flow eliminating the molten material produced by said cutting and/or ablation and limiting the temperature of said lead strip.

6. The method, according to claim 1, further comprising synchronizing the cutting and/or ablation step with the advancement of said lead strip being worked.

7. The method, according to claim 1, further comprising controlling the position of said at least one laser beam according to a selected cutting path, and controlling the focus position of said beam.

8. The method, according to claim 1, further comprising picking up said strip, downstream of said cutting and ablation station by means of a conveyance system which is synchronous with the feeding system.

9. The method according to claim 1, further comprising multiple laser heads which work simultaneously on said lead strip, some of said heads cutting said strip and others of said heads performing ablation.

10. The method according to claim 9, wherein said ablation is performed along a path which is longer than a path of performance of said cutting.
